(19) United States
(12) Patent Application Publication
(10) Pub. No.: US 2019/0076333 A1
(43) Pub. Date: Mar. 14, 2019

(54) Secure Pill Dispenser

(71) Applicant: Jim Moore, Nashville, TN (US)

(72) Inventor: Jim Moore, Nashville, TN (US)

(21) Appl. No.: 15/701,386

(22) Filed: Sep. 11, 2017

(51) Int. Cl. A61J 7/04; G06F 19/00; G07F 17/00; G07F 11/16; A61J 7/00

(52) U.S. Cl. CPC A61J 7/0445; G06F 19/3462; A61J 7/0481; G07F 17/0092; B65D 83/0409; G07F 11/16; A61J 7/0076; A61J 2200/30; A61J 7/0418; A61J 7/0472

(57) ABSTRACT

A portable pill/tablet/capsule dispensing device. The device's purpose is to enhance the doctor/patient relationship by providing patient doses of medication as prescribed by physician. Since medications are consumed outside of the supervision of the prescribing entity, this device helps to affirm to the prescriber that medications are taken by the patient as prescribed, thus minimizing the potential for medical abuse. The device's body has 2 clam shell halves, ultrasonically welded together and therefore the contents inside the device are not accessible by the patient without proper authorization. The device uses a variety of disposable magazines, prefilled with medications to load into the device by an authorized medication provider. Medications within the device are regulated by a computer program which allows for variable time dosing of medication types according to the patient's needs. Attempts to access medication outside the allowed time intervals are denied and logged for later downloading into the patients file for review.

### FIELD OF INVENTION

This invention pertains to dispensing of medications in either pill, tablet, or capsule form. The device contains certain electronic controls to assist the physician in assuring that the patient is using the medication in the prescribed manner.

### BACKGROUND OF INVENTION

Abuse of prescribed medications has led to a growing opioid epidemic worldwide. The problem has exponentially increased to the point that the President of the United States as well as many members of congress, the senate, governors, and local elected officials have declared a State of Emergency to combat the epidemic. On an average day in the U.S., more than 650,000 opioid prescriptions are dispensed and 78 people die from opioid-related overdoses. The economic impact is also troubling, by contributing over 55 billion in health and social costs and 20 billion in emergency department and inpatient care.

Many devices have been configured to deal with the dispensing of medications at an institutional level in various forms and fashions. Such devices usually involve one or more of the following features: an intravenous pump for pain medications with a lock out feature, a bedside device with an alarm and/or light to indicate the next compartmentalized medication should be taken, an alarm and/or light to indicate the device has made the medication available for consuming based on a timed interval. Many of these devices have been used by patients outside of supervised care. One such device is U.S. Pat. No. 5,562,231 A which allows for compartmentalization of medications to be dispensed in a timely manner through a carousel and gating process. The design of this device is to assist in the timely delivery of medication but precludes certain security features which would give the patient access to medications outside the prescribed interval. In another case, U.S. Pat. No. 7,896,192 takes this process a step further in that is may require the user to enter a code prior to the indexing of medications for consumption. The patient and/or other parties would be effectively locked out of the required dose until this code is entered. This device is a variation of the carousel type of pill dispenser and is portable but has only 15% of the pill capacity of our device. For chronic pain users, this requires the patient to refill the device 7 times as compared to once for our device. To take the security issue further, U.S. Pat. No. 6,702,146 uses a sophisticated pill sortation control center to load either single or multiple carousels based on the prescription provided. The medications are inventoried in a sortation center and a control center processes the prescription and deposits medications into the proper compartment in a carousel. The carousel is then placed on the device that is to be used by patient and secured with a lid. These carousels can be placed individually in the device housing or stacked so that a larger supply of medications over a period of time can be dispensed. This device is not portable and inherently expensive to manage and operate.

These patented devices are effective but have missed the mark when it comes to delivering a user friendly and cost-effective solution for the patient who requires pain medications. Unlike the aforementioned medication dispensing devices, the proposed device addresses the user's needs for having a long-term supply of needed medication, in a secure device, which is portable. This device will be commercially available through Medical professionals i.e., Pain Clinics, Psychiatrists, rehabilitation clinics, and General Practitioners. The Medical professional will be able to monitor the patients' use of opioids and will create a better continuum of care, ultimately saving lives, and reducing the economic impact on all.

### BRIEF SUMMARY OF INVENTION

According to one embodiment, the present invention comprises a dispenser which contains a magazine of like medications which are dispensed in a constant time interval set by an authorized entity who loads the device. The magazine is loaded with the prescribed product for insertion into the device. Timed access to the medication is controlled by an on-board controller which is set by an authorized entity while they are loading the device. The patient can access the medication once an LED light/switch on the device is activated by the controller according to the predetermined time interval indicating that the dose is ready for administering. The light remains active until the patient presses the LED light/switch which (a) rotates a sprocket inside the device thus advancing the medication, (b) advances the program to the next timed interval and (c) turns off the LED light/switch. The dose is presented to the patient who then removes it from the device for consumption. Should the patient attempt to access the medication outside the preprogrammed time interval, the attempt is logged but the medication is not dispensed.

According to another embodiment, the present invention comprises a dispenser which contains a magazine of like medications which are dispensed in a variable time interval set by an authorized entity who loads the device. The magazine is loaded with the prescribed product for insertion into the device. The variable time is determined by the prescribing physician and entered into a computer by the administering entity and uploaded to the device. Timed access to the medication is controlled by an on-board controller which was set by an authorized entity while they were loading the device. The patient can access the medication once an LED light/switch on the device is activated by the controller according to the predetermined time interval indicating that the dose is ready for administering. The light remains active until the patient presses the LED light/switch which (a) rotates a sprocket inside the device thus advancing the medication, (b) advances the program to the next timed interval and (c) turns off the LED light/switch. The dose is presented to the patient who then removes it from the device for consumption. Should the patient attempt to access the medication outside the preprogrammed time interval, the attempt is logged but the medication is not dispensed.

According to another embodiment, the present invention comprises a dispenser which contains a magazine of dissimilar medications which are dispensed in a variable time interval set by an authorized entity who loads the device. Medications are loaded into the magazine in a sequence as prescribed by the doctor. The time interval is determined by the prescribing physician for administering each type of medication in the magazine. Timed access to the medication is controlled by an on-board controller which is set by an authorized entity while they are loading the device. The patient can access the medication once an LED light/switch on the device is activated by the controller according to the predetermined time interval indicating that the dose is ready for administering. The light remains active until the patient presses the LED light/switch which (a) rotates a sprocket inside the device thus advancing the medication, (b) advances the program to the next timed interval and (c) turns off the LED light/switch. The dose is presented to the patient who then removes it from the device for consumption. Should the patient attempt to access the medication outside the preprogrammed time interval, the attempt is logged but the medication is not dispensed.

### BRIEF DESCRIPTION OF DRAWINGS

FIG. 1 shows the outer shell of the assembled device.

FIG. 2 shows the medication device with the top clam shell (15) removed. The bottom clam shell (1) shows the location of the internal mechanisms as well as the circuit board location (10) and the medication track (21).

FIG. 3 shows all of the molded forms for the bottom clam shell (1).

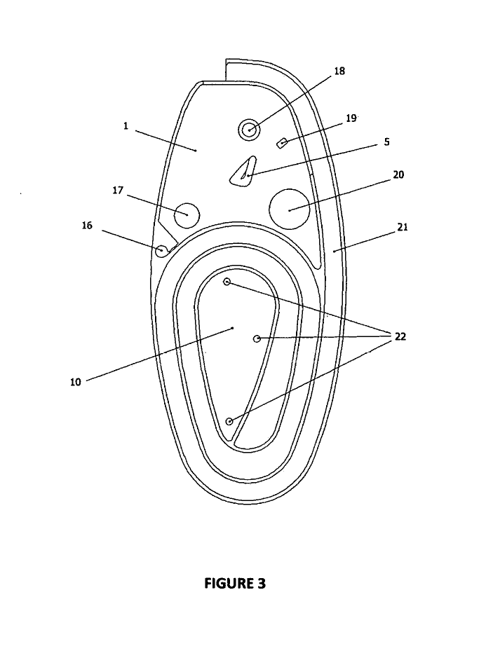

FIG. 4 shows the location of the mechanical components that advance the medication through the device.

FIG. 5 shows the stages of mechanical movement that advances the medication through the device. The device follows the path along the track (5) for each stage of the actuation.

FIG. 6 shows both the magazine (6A) which is filled by an authorized medication provider/pharmacy prior to insertion into the device and the magazine (6B) that is preloaded by a medication supplier for distribution to the medication provider/pharmacy for insertion into the device.

FIG. 7 shows the location and main components of the circuit board and power supply that controls the timing and frequency of medication distribution.

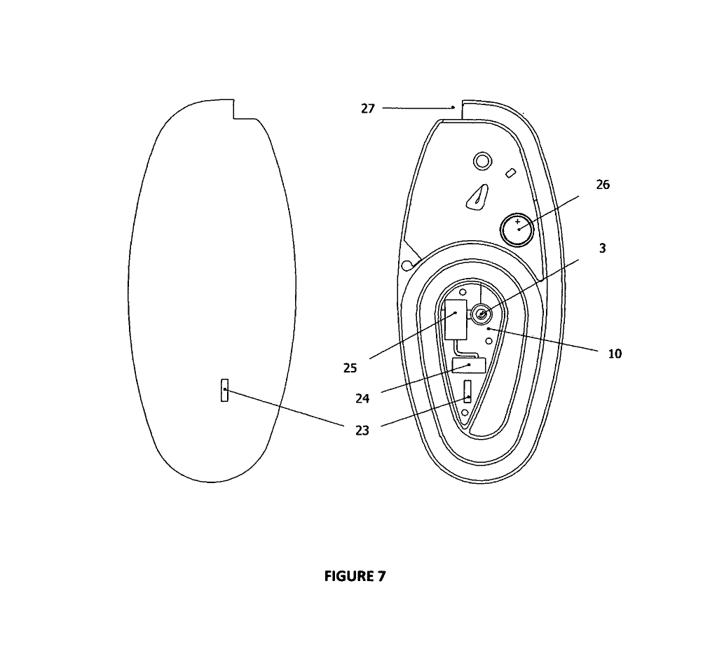

FIG. 8 shows a cross section of the device as well as the top clam shell and bottom clam shell prior to the assembly and sealing of the device.

### DETAILED DESCRIPTION OF INVENTION

The following description of the Invention will illustrate the form and function of the device. Certain components will not be described in complete detail, however those skilled in the art will glean the functionality of the device based on the description that follows and the illustrations that have been listed with captions for each figure.

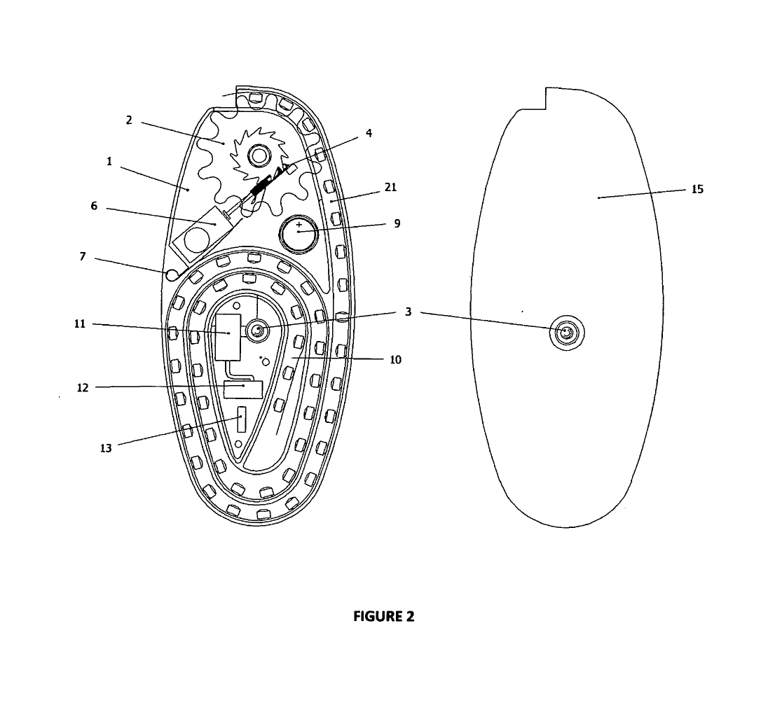

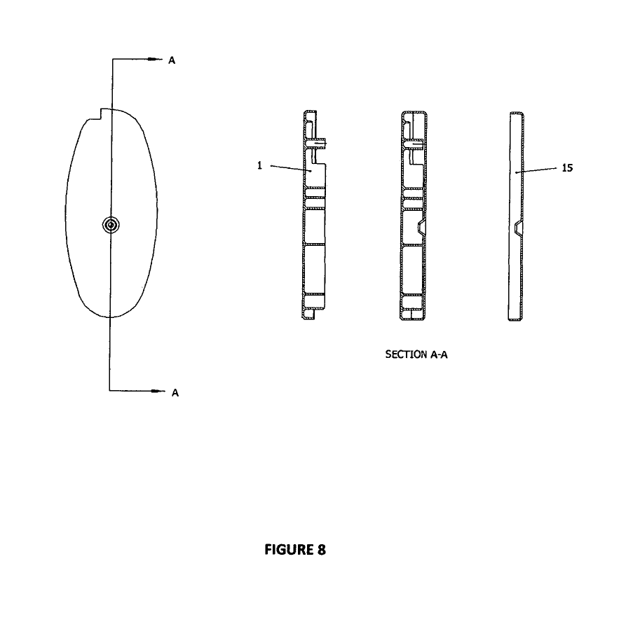

A medication dispensing device as shown in FIG. 2 is comprised of an upper clam shell (15) and a lower clam shell (1) with the following components attached; a linear actuator (6) and a cam following attachment (4), an indexing sprocket (2), a spring tensioner (7), a circuit board (10), and a power supply (9), all installed prior to affixing the 2 clam shells together (FIG. 8 Section A-A) to seal the assembly.

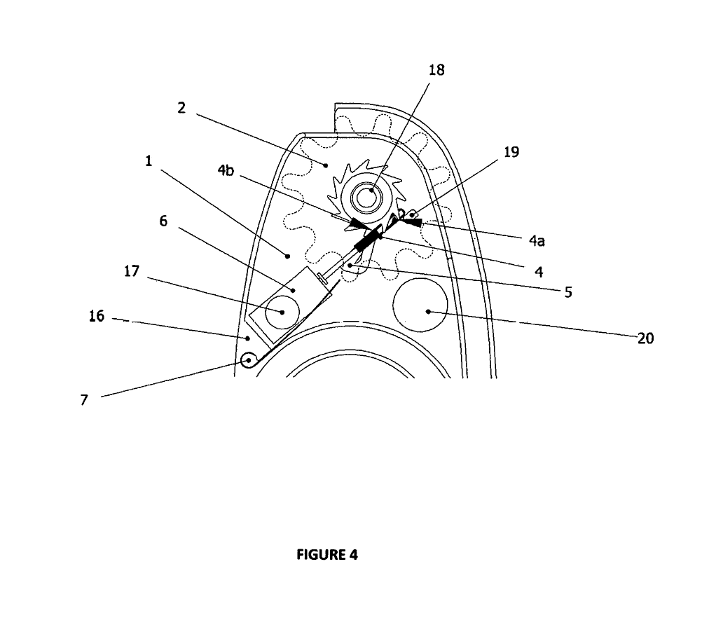

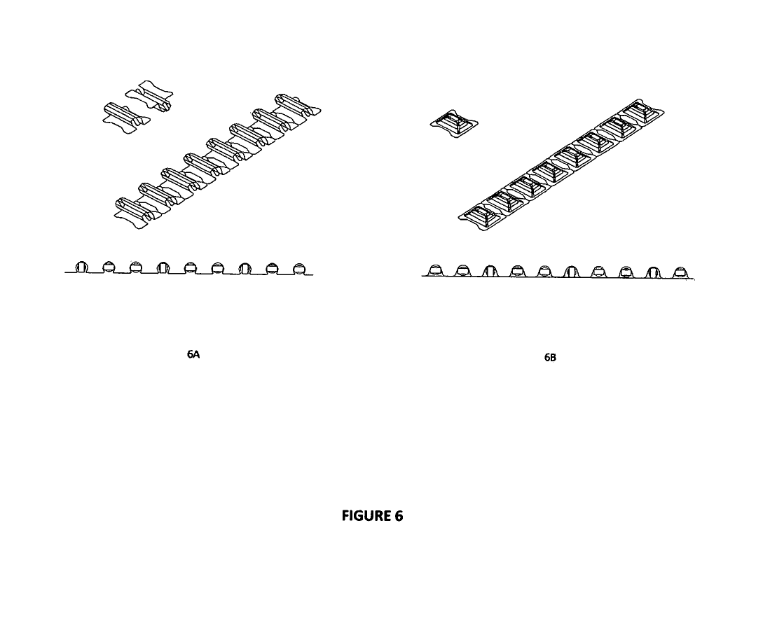

The molded lower clam shell (1) as shown in FIG. 2 contains features essential to the movement of either of the magazine styles (FIGS. 6A & 6B) through the device. From FIG. 2, the magazine pathway (21) allows the magazine to be inserted and coil into the device for loading up to 50 compartments that houses pills, capsules, or tablets. From FIG. 4, the components are assembled onto the base as follows: the linear actuator (6) is affixed to the pivot base cavity (17), the indexing sprocket (2) is mounted onto embossment (18), the spring tensioner (7) is inserted into cavity (16), the circuit board (10) is affixed to posts (22) and the power supply (9) is placed in recess (20).

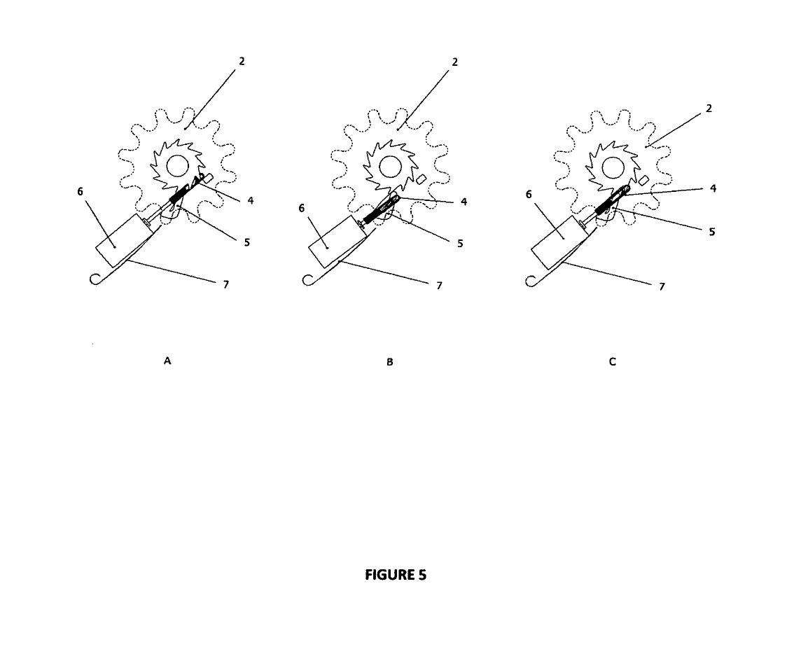

Once assembled and the 2 clam shells are welded together, the device can be loaded with medications. To load the device, a pharmacy or authorized medical provider will connect the device to a computer through the USB interface (23). Alternatively, the circuit board (10) can be configured to interface with the computer through a blue tooth device. Once connected, the device will trigger the computer to launch a secure program to perform 3 simultaneous functions. First, the connection will launch a program where the administrator will enter the time interval under which the device will index medication. The administrator has the option to set the interval for all doses to be at the same interval or set each dose interval independently. If the patient is refilling their device, the administrator will download any data collected by the on-board chip in the device. The information that has been collected is the date and time stamp from when the patient had depressed the limit switch (3) in order to dispense medication. Second, the program will cause the linear actuator (6) to retract to the position shown in FIG. 5 illustration B and hold that position. This action frees the indexing sprocket (2) which allows the sprocket to rotate freely. Now, a magazine (6A or 6B) can be inserted through the device opening (27). Third, while the device is connected to the computer, the batteries can be recharged. Once disconnected from the computer, the linear actuator will reset to the locked position and the program will initiate the on-board program (25), and start the timer/clock (24) to ready the device for dispensing medication.

The patient need only interface with the device by depressing the limit switch (3) once the LED light, which is a feature of the limit switch, indicates that the appropriate interval has been reached for dispensing medication. If the limit switch is depressed when the light is not illuminated, the on-board program (25) will record that instance along with the time the switch is depressed.

It is necessary to point out that in FIG. 4, the actuator (6) is in the resting state where the inherent spring mechanism has extended the travel of the actuator to its fullest position. This is also shown in FIG. 5 illustration A. In this position, the cam following attachment (4) has engaged the indexing sprocket at position (4a) having rotated the sprocket counterclockwise to its present location while the base of the cam following attachment stops the sprocket from advancing further at area (4b). To help secure the locked position the tip of the cam follower will nest between the locking post (19) and the sprocket. In this position, the cam follower has blocked the sprocket from freely moving in either direction. This is the position in which the patient receives the device.

Referring to FIG. 5 the indexing of the medication magazine has 3 distinct phases. To dispense medication the user waits for the limit switch (3) to illuminate and then depresses the button. At this moment, the linear actuator is shown in position A. Depressing the limit switch causes the linear actuator to retract and the cam follower (4) which is mounted on the end of the linear actuator to retract along the cam path (5) thus coming to rest in position B. The actuator immediately advances to position C where the cam follower reengages the sprocket and finally comes to rest back at position A. This sequence causes the sprocket to rotate 30 degrees in a counterclockwise fashion and causes one compartment with medication to exit the device and simultaneously lock the device. The timer is then restarted according to the interval set by the administrator. The patient can then remove the medication for consumption.

What is claimed is:

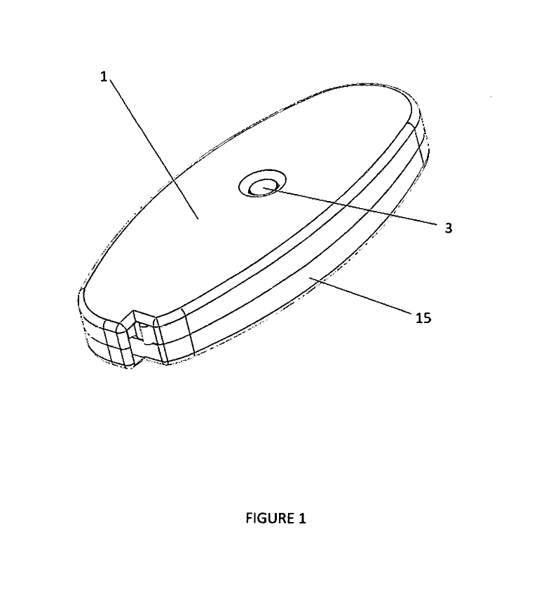

1) A medical device to dispense pills, capsules, or tablets to patients in a compact portable design (FIG. 1) in accordance with a preprogramed time interval. The device comprises:
a) A solid housing comprised of 2 halves ultrasonically welded together.
b) A channel (21) capable of inserting a medication magazine (6A or 6B).
c) A sprocket (2) with teeth spaced to fill the void between medication compartments of the medication magazine (FIG. 2).
d) A linear actuator (6) which indexes the sprocket.
e) A circuit board (10) for initiating the internal mechanisms and logging patient data.
f) A power source (26) to supply to energy to the circuit board components as well as the linear actuator.

2) The medication dispenser of claim 1 further comprising a locking post (19) to stabilize the linear actuator to prevent movement of the magazine outside of the prescribed intervals.

3) The medication dispenser of claim 1 further comprising a retention spring (7) to restrict movement of the linear actuator to its designated pathway.

4) The medication dispenser of claim 1 further comprising a USB port (23) or or Blue Tooth interface to access a remote computer program.

5) The medication dispenser of claim 4 further comprising a program on an external computer to:
a) download patient data stored on the circuit board's controller.
b) activate the linear actuator to allow authorized personnel to load a medication magazine into the device, and
c) recharge the power supply.

6) The medication dispenser of claim 1 further comprising a CAM channel to control the path of the linear actuator's function.

7) The medication dispenser of claim 1 further comprising a limit switch to provide the patient with a mechanism to activate the sequencing of the medication magazine.

8) The medication dispenser of claim 7 further comprising an integrated LED to indicate to the patient that medication is ready to dispense.

9) The medication dispenser of claim 1 further comprising a clock/timer (24) interfaced to the controller to initiate the sequence of events stored in the controller to advance the medication magazine through the device.

10) The medication dispenser of claim 1 further comprising the use of a medication magazine based on industry standard blister packs (BLPK's) manufactured to dimensionally fit the cavity and feed lengths required to dispense medications.
